(19) United States
(12) Patent Application Publication
(10) Pub. No.: US 2022/0352511 A1
(43) Pub. Date: Nov. 3, 2022

(54) LITHIUM TRANSITION METAL OXIDE ELECTRODES INCLUDING ADDITIONAL METALS AND METHODS OF MAKING THE SAME

(71) Applicant: GM GLOBAL TECHNOLOGY OPERATIONS LLC, Detroit, MI (US)

(72) Inventors: Gongshin QI, Troy, MI (US); Sonam PATEL, Rochester Hills, MI (US)

(73) Assignee: GM GLOBAL TECHNOLOGY OPERATIONS LLC, Detroit, MI (US)

(21) Appl. No.: 17/242,301

(22) Filed: Apr. 28, 2021

(51) Int. Cl. H01M 4/525; H01M 4/505; H01M 4/36; H01M 4/62; H01M 4/1391; H01M 4/04; H01M 4/131; C01G 53/00

(52) U.S. Cl. CPC H01M 4/525; H01M 4/505; H01M 4/366; H01M 4/622; H01M 4/1391; H01M 4/0471; H01M 4/0404; H01M 4/131; C01G 53/50; H01M 2004/021

(57) ABSTRACT

A lithium transition metal oxide electrode including an additional metal is provided herein as well electrochemical cells including the lithium transition metal oxide electrode and methods of making the lithium transition metal oxide electrode. The lithium transition metal oxide electrode includes a first electroactive material including Li₁₊ₐNi_{b}Mn_{c}Co_{d}MₑO₂, where 0.05≤a≤0.5; 0.1≤b≤0.5; 0.3≤c≤0.8; 0≤d≤0.3; 0.001 ≤e≤0.1; a+b+c+d+e=1, and M represents an additional metal, such as W, Mo, V, Zr, Nb, Ta, Fe, Al, or a combination thereof.

### FIELD

The present disclosure relates to electrodes containing lithium transition metal oxides including additional metals, such as tungsten, molybdenum, vanadium, etc., electrochemical cells including the electrodes, and methods for making the electrodes.

### BACKGROUND

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a relatively high concentration of intercalated lithium, which is oxidized into lithium ions and electrons. The lithium ions travel from the negative electrode (anode) to the positive electrode (cathode), for example, through the ionically conductive electrolyte solution contained within the pores of an interposed porous separator. At the same time, the electrons pass through the external circuit from the negative electrode to the positive electrode. The lithium ions may be assimilated into the material of the positive electrode by an electrochemical reduction reaction. The battery may be recharged after a partial or full discharge of its available capacity by an external power source, which reverses the electrochemical reactions that transpired during discharge.

Layered lithium transition metal oxides, such as lithium- and manganese-rich layered cathode oxides (LLC), are attractive candidates as electroactive materials for positive electrodes for lithium-ion batteries because they exhibit higher capacity (>250 mAh/g) and are less expensive than other commercially available cathode materials.

In spite of the high capacity of LLC materials there remain fundamental challenges preventing its commercial application. These include irreversible capacity loss during the first cycle, poor cycling stability, capacity fade and voltage decay during cycling, short calendar and cycle life, and fast resistance rise at low state of charge (SOC). These challenges are related to the manganese-rich nature and the structural instability of these materials induced by the oxidation of oxygen anions. Indeed, considerable research has already been devoted to understanding the structural evolution of such materials.

It would be desirable to develop LLCs materials for lithium ion batteries, for use in lithium ion batteries, which overcome the current shortcomings that prevent their widespread commercial use. Accordingly, it would be desirable to develop materials for lithium ion batteries, particularly LLC materials for positive electrodes, which exhibit greater capacity and improved cycling stability.

### SUMMARY

This section provides a general summary of the disclosure and is not a comprehensive disclosure of its full scope or all of its features.

In certain aspects, the present disclosure provides an electrode. The electrode includes a first electroactive material. The first electroactive material includes Li₁₊ₐNi_{b}Mn_{c}Co_{d}MₑO₂, where 0.05≤a≤0.5; 0.1≤b≤0.5; 0.3≤c≤0.8; 0≤d≤0.3; 0.001≤e≤0.1; a+b+c+d+e=1; and M represents an additional metal selected from the group consisting of W, Mo, V, Zr, Nb, Ta, Fe, Al, and a combination thereof. For example, M may be W, Mo, V, Zr, Nb, Ta, Fe, or a combination thereof or M may be W, Mo, or a combination thereof.

The additional metal may be present: (i) doped within the first electroactive material; (ii) as a metal oxide layer; or (iii) a combination thereof.

The metal oxide layer may be present on a surface of the first electroactive material. Additionally or alternatively, the metal oxide layer has a thickness of about 1 nm to about 100 nm.

The first electroactive material may be present in an amount of about 40 wt. % to about 95 wt. %, based on total weight of the electrode.

The electrode may further include a polymeric binder, an electrically conductive material, or a combination thereof.

In yet other aspects, the present disclosure provides an electrochemical cell. The electrochemical cell includes a positive electrode including a first electroactive material, a negative electrode including a second electroactive material, wherein the positive electrode is spaced apart from the negative electrode, a porous separator disposed between confronting surfaces of the positive electrode and the negative electrode, and a liquid electrolyte infiltrating one or more of: the positive electrode, the negative electrode, and the porous separator. The first electroactive material includes Li₁₊ₐNi_{b}Mn_{c}Co_{d}MₑO₂, where 0.05≤a≤0.5; 0.1≤b≤0.5; 0.3≤c≤0.8; 0≤d≤0.3; 0.001≤e≤0.1; a+b+c+d+e=1; and M represents an additional metal selected from the group consisting of W, Mo, V, Zr, Nb, Ta, Fe, Al, and a combination thereof. For example, M may be W, Mo, V, Zr, Nb, Ta, Fe, or a combination thereof or M may be W, Mo, or a combination thereof.

The additional metal may be present: (i) doped within the first electroactive material; (ii) as a metal oxide layer; or (iii) a combination thereof.

The metal oxide layer may be present on a surface of the first electroactive material. Additionally or alternatively, the metal oxide layer has a thickness of about 1 nm to about 100 nm.

The first electroactive material may be present in an amount of about 40 wt. % to about 95 wt. %, based on total weight of the electrode.

The electrode may further include a polymeric binder, an electrically conductive material, or a combination thereof.

The second electroactive material includes metallic lithium, a lithium alloy, silicon, graphite, activated carbon, carbon black, hard carbon, soft carbon, graphene, tin oxide, aluminum, indium, zinc, germanium, silicon oxide, titanium oxide, lithium titanate, and a combination thereof.

Each of the positive electrode and the negative electrode may further include a polymeric binder, an electrically conductive material, or a combination thereof.

In yet other aspects, the present disclosure provides a method of preparing an electrode. The method includes combining one or more first metal precursor, a second metal precursor, and a solution to form a precursor mixture. The one or more first metal precursor may be one or more salt of a first metal, for example, the first metal may be lithium, manganese, nickel, cobalt, or a combination thereof. The second metal precursor may be a salt, an acid, or an oxide, of a second metal, for example, the second metal may be tungsten, molybdenum, vanadium, zirconium, niobium, tantalum, iron, aluminum, or a combination thereof. The method may further include drying the precursor mixture to form an intermediate mixture, calcining the intermediate mixture, for example, at a temperature of about 700° C. to about 1250° C. for about 10 hours to about 30 hours, to form a calcined intermediate mixture, and quenching the calcined intermediate mixture, for example, at a temperature of about 15° C. to about 25° C., to form a first electroactive material. The first electroactive material includes Li₁₊ₐNi_{b}Mn_{c}Co_{d}MₑO₂, where 0.05≤a≤0.5; 0.1≤b≤0.5; 0.3≤c≤0.8; 0≤d≤0.3; 0.001≤e≤0.1; a+b+c+d+e=1; and M represents an additional metal selected from the group consisting of W, Mo, V, Zr, Nb, Ta, Fe, Al, and a combination thereof. For example, M may be W, Mo, V, Zr, Nb, Ta, Fe, or a combination thereof or M may be W, Mo, or a combination thereof.

The method may further include combining the first electroactive material with a solvent to form a slurry, applying the slurry to a current collector, and drying the slurry to remove the solvent and form the electrode.

The additional metal may be present: (i) doped within the first electroactive material; (ii) as a metal oxide layer; or (iii) a combination thereof.

The metal oxide layer may be present on a surface of the first electroactive material. Additionally or alternatively, the metal oxide layer has a thickness of about 1 nm to about 100 nm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery cell.

FIG. 2 is a schematic of an exemplary battery.

FIG. 3 is a graph depicting discharge capacity (mAh/g) versus cycle number for the anode of each of Cells 1-4 formed according to Example 2 after cycling at C/5.

FIG. 4 is a graph depicting charging capacity and discharging capacity of the first formation cycle (C/20) for the anode of each of Cells 1-4 formed according to Example 2.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” “attached to,” or “coupled to” another element or layer, it may be directly on, engaged, connected, attached or coupled to the other component, element, or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

### I. Electrochemical Cell

Lithium-containing electrochemical cells typically include a negative electrode, a positive electrode, an electrolyte for conducting lithium ions between the negative and positive electrodes, and a porous separator between the negative electrode and the positive electrode to physically separate and electrically insulate the electrodes from each other while permitting free ion flow. When assembled in an electrochemical cell, for example, in a lithium-ion battery, the porous separator is infiltrated with a liquid electrolyte. The present disclosure pertains to improved LLC materials for electrochemical cells (e.g., lithium ion batteries), in particular for positive electrodes. It has been discovered that inclusion of an additional metal, such as tungsten, molybdenum, and the like, in the LLC material can improve electrode performance. For example, the electrode can demonstrate higher capacity as well as more stable cycling performance.

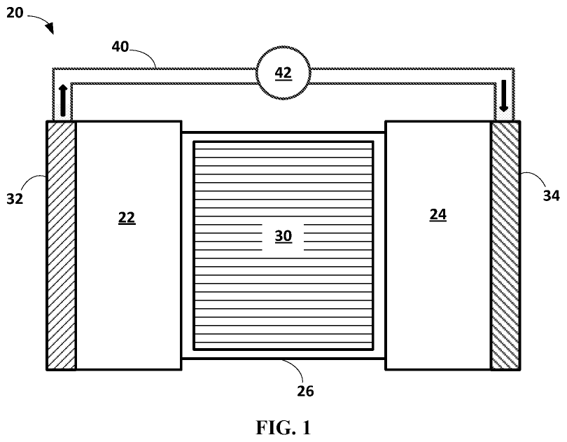

An electrochemical cell for use in a battery, for example, a lithium ion battery, or as a capacitor is provided herein. For example, an exemplary and schematic illustration of an electrochemical cell (also referred to as the lithium ion battery or battery) 20 is shown in FIG. 1. Electrochemical cell 20 includes a negative electrode 22 (also referred to as a negative electrode layer 22), a positive electrode 24 (also referred to as a positive electrode layer 24), and a separator 26 (e.g., a microporous polymeric separator) disposed between the two electrodes 22, 24. The space between (e.g., the separator 26) the negative electrode 22 and positive electrode 24 can be filled with the electrolyte 30. If there are pores inside the negative electrode 22 and positive electrode 24, the pores may also be filled with the electrolyte 30. The electrolyte 30 can impregnate, infiltrate, or wet the surfaces of and fill the pores of each of the negative electrode 22, the positive electrode 24, and the porous separator 26. A negative electrode current collector 32 may be positioned at or near the negative electrode, 22 and a positive electrode current collector 34 may be positioned at or near the positive electrode 24. The negative electrode current collector 32 and positive electrode current collector 34 respectively collect and move free electrons to and from an external circuit 40. An interruptible external circuit 40 and load device 42 connects the negative electrode 22 (through its current collector 32) and the positive electrode 24 (through its current collector 34). Each of the negative electrode 22, the positive electrode 24, and the separator 26 may further comprise the electrolyte 30 capable of conducting lithium ions. The separator 26 operates as both an electrical insulator and a mechanical support, by being sandwiched between the negative electrode 22 and the positive electrode 24 to prevent physical contact and thus, the occurrence of a short circuit. The separator 26, in addition to providing a physical barrier between the two electrodes 22, 24, can provide a minimal resistance path for internal passage of lithium ions (and related anions) for facilitating functioning of the battery 20. The separator 26 also contains the electrolyte solution in a network of open pores during the cycling of lithium ions, to facilitate functioning of the battery 20.

The battery 20 can generate an electric current during discharge by way of reversible electrochemical reactions that occur when the external circuit 40 is closed (to connect the negative electrode 22 and the positive electrode 24) when the negative electrode 22 contains a relatively greater quantity of inserted lithium. The chemical potential difference between the positive electrode 24 and the negative electrode 22 drives electrons produced by the oxidation of inserted lithium at the negative electrode 22 through the external circuit 40 toward the positive electrode 24. Lithium ions, which are also produced at the negative electrode, are concurrently transferred through the electrolyte 30 and separator 26 towards the positive electrode 24. The electrons flow through the external circuit 40 and the lithium ions migrate across the separator 26 in the electrolyte 30 to form intercalated lithium at the positive electrode 24. The electric current passing through the external circuit 40 can be harnessed and directed through the load device 42 until the inserted lithium in the negative electrode 22 is depleted and the capacity of the lithium ion battery 20 is diminished.

The lithium ion battery 20 can be charged or re-powered/re-energized at any time by connecting an external power source to the lithium ion battery 20 to reverse the electrochemical reactions that occur during battery discharge. The connection of an external power source to the lithium ion battery 20 compels the otherwise non-spontaneous oxidation of intercalated lithium at the positive electrode 24 to produce electrons and lithium ions. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with inserted lithium for consumption during the next battery discharge event. As such, a complete discharging event followed by a complete charging event is considered to be a cycle, where lithium ions are cycled between the positive electrode 24 and the negative electrode 22. The external power source that may be used to charge the lithium ion battery 20 may vary depending on the size, construction, and particular end-use of the lithium ion battery 20. Some notable and exemplary external power sources include, but are not limited to, an AC wall outlet and a motor vehicle alternator.

In many battery configurations, each of the negative current collector 32, negative electrode 22, the separator 26, positive electrode 24, and positive current collector 34 are prepared as relatively thin layers (for example, several microns or a millimeter or less in thickness) and assembled in layers connected in electrical parallel arrangement to provide a suitable energy package. The negative electrode current collector 32 and positive electrode current collector 34 respectively collect and move free electrons to and from an external circuit 40.

Furthermore, the battery 20 can include a variety of other components that while not depicted here are nonetheless known to those of skill in the art. For instance, the lithium ion battery 20 may include a casing, gaskets, terminal caps, tabs, battery terminals, and any other conventional components or materials that may be situated within the battery 20, including between or around the negative electrode 22, the positive electrode 24, and/or the separator 26, by way of non-limiting example. The battery 20 shown in FIG. 1 includes a liquid electrolyte 30 and shows representative concepts of battery operation.

As noted above, the size and shape of the lithium ion battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium ion cells or batteries to produce a greater voltage output and power density if it is required by the load device 42.

Accordingly, the battery 20 can generate electric current to a load device 42 that can be operatively connected to the external circuit 40. The load device 42 may be powered fully or partially by the electric current passing through the external circuit 40 when the lithium ion battery 20 is discharging. While the load device 42 may be any number of known electrically-powered devices, a few specific examples of power-consuming load devices include an electric motor for a hybrid vehicle or an all-electrical vehicle, a laptop computer, a tablet computer, a cellular phone, and cordless power tools or appliances, by way of non-limiting example. The load device 42 may also be a power-generating apparatus that charges the battery 20 for purposes of storing energy.

The present technology pertains to improved electrochemical cells, especially lithium-ion batteries. In various instances, such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

### A. Positive Electrode

In various aspects, a lithium transition metal oxide electrode, such as positive electrode 24 (FIG. 1), is provided herein. The positive electrode 24 may be formed from a first electroactive material, such as a layered lithium transition metal oxide, that can sufficiently undergo lithium intercalation and deintercalation while functioning as the positive terminal of the lithium ion battery 20.

In any embodiment, the first electroactive material may include a lithium-and manganese-rich layered oxide (LLC) material. The LLC material may be represented by the formula, Li₁₊ₐNi_{b}Mn_{c}Co_{d}MₑO₂, wherein 0.02≤a≤0.5; 0.08≤b≤0.8; 0.1≤c≤0.9; zero (0)≤d≤0.5; 0.001<e≤0.4; and a+b+c+d+e=1. Additionally or alternatively, 0.05≤a≤0.3 or 0.5; 0.1≤b≤0.5; 0.3≤c≤0.8; zero (0) ≤d ≤0.3; 0.001≤e≤0.1; and a +b+c+d+e=1. Additionally or alternatively, 0.1≤a≤0.3; 0.1≤b≤0.3; 0.4≤c≤0.6; zero (0)≤d≤0.1, 0.009≤e≤0.1; and a+b+c+d+e=1. M can represent an additional metal selected from the group consisting of tungsten (W), molybdenum (Mo), vanadium (V), zirconium (Zr), niobium (Nb), tantalum (Ta), iron, (Fe), aluminum (Al), and a combination thereof. Additionally or alternatively, M can be W, Mo, V, Zr, Nb, Ta, Fe, and a combination thereof. In some embodiments, M can be W, Mo, or a combination thereof.

Examples of the first electroactive material include, but are not limited to:

Li_{1.2}Ni_{0.16}Mn_{0.51}Co_{0.08}Al_{0.05}O₂;
Li_{1.2}Ni_{0.16}Mn_{0.55}Co_{0.08}W_{0.01}O₂;
Li_{1.2}Ni_{0.16}Mn_{0.54}Co_{0.08}Mo_{0.02}O₂; and combinations thereof.

In any embodiment, the additional metal may be present within the first electroactive material, on the first electroactive material, or a combination thereof. For example, the additional metal may be present doped within the first electroactive material and/or as a dopant within the first electroactive material. As used herein, “doping” or “dopant” refers the additional metal atoms (e.g., W atoms, Mo atoms, V atoms, etc.) present within a lattice structure of the first electroactive material. For example, the additional metal atoms may be present as substitutional on the Li, Mn, Ni, and/or Co atomic sites, located interstitially, as interstitial inclusions, in the lattice structure or a combination thereof.

Additionally or alternatively, the additional metal may be present as a metal oxide layer. The metal oxide layer may be present on a surface of the first electroactive material. For example, if the first electroactive material is present in particulate form, the metal oxide layer may be present on a surface of a plurality of or substantially all of the first electroactive material particles. In any embodiment, the metal oxide layer may include one or more tungsten oxide (e.g., W₂O₃, WO₂, WO₃, W₂O₅, etc.), one or more molybdenum oxide (e.g., MoO₂, MoO₃, Mo₈O₂₃, Mo₁₇O₄₇, etc.), one or more vanadium oxide (e.g., VO, V₂O₃, VO₂, V₂O₅, V₃O₇, V₄O₉, V₆O₁₃, V₄O₇, V₅O₉, V₆O₁₁, V₇O₁₃, V₈O₁₅, V₃O₅, etc.), one or more zirconium oxide (e.g., ZrO₂), one or more niobium oxide (e.g., NbO, NbO₂, Nb₂O₅, Nb₁₂O₂₉, Nb₄₇O₁₁₆, Nb₃ₙ₊₁O₈ₙ₋₂ where 5≤n≤8, etc.), one or more tantalum oxide (e.g., Ta₂O₅), one or more aluminum oxide (e.g., Al₂O₃, α-Al₂O₃, β-Al₂O₃, γ-Al₂O₃, η-Al₂O₃, θ-Al₂O₃, κ-Al₂O₃ particles, χ-Al₂O₃, σ-Al₂O₃ ,etc.) and combinations thereof.

In any embodiment, the metal oxide layer may have thickness of greater than or equal to about 1 nm, greater than or equal to about 10 nm, greater than or equal to about 25 nm, greater than or equal to about 50 nm, greater than or equal to about 75 nm, greater than or equal to about 100 nm, greater than or equal to about 250 nm, or about 500 nm; or from about 1 nm to about 500 nm, about 1 nm to about 250 nm, about 1 nm to about 100 nm, about 1 nm to about 75 nm, about 1 nm to about 50 nm, about 1 nm to about 25 nm, or about 1 nm to about 10 nm.

It is contemplated herein that the first electroactive material may be in particle form and may have a round geometry or an axial geometry. The term “axial geometry” refers to particles generally having a rod, fibrous, or otherwise cylindrical shape having an evident long or elongated axis. Generally, an aspect ratio (AR) for cylindrical shapes (e.g., a fiber or rod) is defined as AR=L/D where L is the length of the longest axis and D is the diameter of the cylinder or fiber. Exemplary axial-geometry electroactive material particles suitable for use in the present disclosure may have high aspect ratios, ranging from about 10 to about 5,000, for example. In certain variations, the first electroactive material particles having an axial-geometry include fibers, wires, flakes, whiskers, filaments, tubes, rods, and the like.

The term “round geometry” typically applies to particles having lower aspect ratios, for example, an aspect ratio closer to 1 (e.g., less than 10). It should be noted that the particle geometry may vary from a true round shape and, for example, may include oblong or oval shapes, including prolate or oblate spheroids, agglomerated particles, polygonal (e.g., hexagonal) particles or other shapes that generally have a low aspect ratio. Oblate spheroids may have disc shapes that have relatively high aspect ratios. Thus, a generally round geometry particle is not limited to relatively low aspect ratios and spherical shapes.

Additionally or alternatively, the positive electrode 24 can optionally include an electrically conductive material and/or a polymeric binder. Examples of electrically conductive material include, but are not limited to, carbon black, graphite, acetylene black (such as KETCHEN™ black or DENKA™ black), carbon nanotubes, carbon fibers, carbon nanofibers, graphene, graphene nanoplatelets, graphene oxide, nitrogen-doped carbon, metallic powder (e.g., copper, nickel, steel or iron), liquid metals (e.g., Ga, GaInSn), a conductive polymer (e.g., include polyaniline, polythiophene, polyacetylene, polypyrrole, and the like) and combinations thereof. As used herein, the term “graphene nanoplatelet” refers to a nanoplate or stack of graphene layers. Such electrically conductive material in particle form may have a round geometry or an axial geometry as described above.

As used herein, the term “polymeric binder” encompasses polymer precursors used to form the polymeric binder, for example, monomers or monomer systems that can form any one of the polymeric binders disclosed above. Examples of suitable polymeric binders, include but are not limited to, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), poly(acrylic acid) PAA, polyimide, polyamide, sodium alginate, lithium alginate, and combinations thereof. In some embodiments, the polymeric binder may be a non-aqueous solvent-based polymer or an aqueous-based polymer. In particular, the polymeric binder may be a non-aqueous solvent-based polymer that can demonstrate less capacity fade, provide a more robust mechanical network and improved mechanical properties to handle silicon particle expansion more effectively, and possess good chemical and thermal resistance. For example, the polymeric binder may include polyimide, polyamide, polyacrylonitrile, polyacrylic acid, a salt (e.g., potassium, sodium, lithium) of polyacrylic acid, polyacrylamide, polyvinyl alcohol, carboxymethyl cellulose, or a combination thereof. The first electroactive material may be intermingled with the electrically conductive material and/or at least one polymeric binder. For example, the first electroactive material and optional electrically conducting materials may be slurry cast with such binders and applied to a current collector. Polymeric binder can fulfill multiple roles in an electrode, including: (i) enabling the electronic and ionic conductivities of the composite electrode, (ii) providing the electrode integrity, e.g., the integrity of the electrode and its components, as well as its adhesion with the current collector, and (iii) participating in the formation of solid electrolyte interphase (SEI), which plays an important role as the kinetics of lithium intercalation is predominantly determined by the SEI.

In any embodiment, the first electroactive material may be present in the positive electrode in an amount, based on total weight of the positive electrode, of greater than or equal to about 30 wt. %, greater than or equal to about 40 wt. %, greater than or equal to about 50 wt. %, greater than or equal to about 60 wt. %, greater than or equal to about 70 wt. %, greater than or equal to about 80 wt. %, greater than or equal to about 90 wt. %, greater than or equal to about 95 wt. %, or about 98 wt. %; or from about 30 wt. % to about 98 wt. %, about 40 wt. % to about 98 wt. %, about 40 wt. % to about 95 wt. %, about 40 wt. % to about 90 wt. %, about 40 wt. % to about 80 wt. %, about 40 wt. % to about 70 wt. %, about 40 wt. % to about 60 wt. %, or about 40 wt. % to about 50 wt. %.

Additionally or alternatively, the electrically conductive material and the polymeric binder each may be independently present in the positive electrode in an amount, based on total weight of the positive electrode from about 0.5 wt. % to about 30 wt. %, about 1 wt. % to about 25 wt. %, about 1 wt. % to about 20 wt. %, about 1 wt. % to about 10 wt. %, about 3 wt. % to about 20 wt. %, or about 5 wt. % to about 15 wt. %.

### B. Negative Electrode

The negative electrode 22 includes a second electroactive material as a lithium host material capable of functioning as a negative terminal of a lithium ion battery. The second electroactive material may be formed from or comprise metallic lithium. It is contemplated herein that the second electroactive material may be comprised of or consist of all metallic lithium (e.g., 100 wt. % lithium based on total weight of the first electroactive material). Additionally or alternatively, the second electroactive material may comprise a lithium alloy, such as, but not limited to, lithium silicon alloy, a lithium aluminum alloy, a lithium indium alloy, a lithium tin alloy, or combinations thereof. The negative electrode 22 may optionally further include one or more of graphite, activated carbon, carbon black, hard carbon, soft carbon, graphene, silicon, tin oxide, aluminum, indium, zinc, germanium, silicon oxide, titanium oxide, lithium titanate, and combinations thereof, for example, silicon mixed with graphite. Non-limiting examples of silicon-containing electroactive materials include silicon (amorphous or crystalline), or silicon containing binary and ternary alloys, such as Si—Sn, SiSnFe, SiSnAl, SiFeCo, and the like. In other variations, the negative electrode 22 may be a metal film or foil, such as a lithium metal film or lithium-containing foil. The second electroactive material may be in particle form and may have a round geometry or an axial geometry as described above.

Additionally, the negative electrode 22 can optionally include an electrically conductive material as described herein and/or a polymeric binder as described herein that improves the structural integrity of the electrode. For example, the second electroactive materials and electronically or electrically conducting materials may be slurry cast with such binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), poly(acrylic acid) PAA, polyimide, polyamide, sodium alginate, or lithium alginate, and applied to a current collector. Examples of electrically conductive material include, but are not limited to, carbon black, graphite, acetylene black (such as KETCHEN™ black or DENKA™ black), carbon nanotubes, carbon fibers, carbon nanofibers, graphene, graphene nanoplatelets, graphene oxide, nitrogen-doped carbon, metallic powder (e.g., copper, nickel, steel or iron), liquid metals (e.g., Ga, GalnSn), a conductive polymer (e.g., include polyaniline, polythiophene, polyacetylene, polypyrrole, and the like) and combinations thereof.

In various aspects, the second electroactive material may be present in the negative electrode in an amount, based on total weight of the negative electrode from about 50 wt. % to about 100 wt. %, about 50 wt. % to about 98 wt. %, about 60 wt. % to about 95 wt. %, about 60 wt. % to about 95 wt. %, or about 60 wt. % to about 80 wt. %. Additionally or alternatively, the electrically conductive material and the polymeric binder each may be independently present in the negative electrode in an amount, based on total weight of the negative electrode from about 0.5 wt. % to about 30 wt. %, about 1 wt. % to about 25 wt. %, about 1 wt. % to about 20 wt. %, about 1 wt. % to about 10 wt. %, about 3 wt. % to about 20 wt. %, or about 5 wt. % to about 15 wt. %.

### C. Current Collectors

The positive electrode current collector 34 may be formed from aluminum (Al) or any other appropriate electrically conductive material known to those of skill in the art. The negative electrode current collector 32 may comprise a metal comprising copper, nickel, or alloys thereof, stainless steel, or other appropriate electrically conductive materials known to those of skill in the art. In certain aspects, the positive electrode current collector 34 and/or negative electrode current collector 32 may be in the form of a foil, slit mesh, and/or woven mesh.

### D. Electrolyte

The positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂) , lithium bis(fluorosulfonyl)imide (LiN(FSO₂)₂) (LiSFI), lithium (triethylene glycol dimethyl ether)bis(trifluoromethanesulfonyl)imide (Li(G3)(TFSI), lithium bis(trifluoromethanesulfonyl)azanide (LiTFSA), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane). One or more salts can be present in the electrolyte in a concentration ranging from about 1 M to about 4 M, for example, about 1 M, about 1 M to 2 M, or about 3 M to about 4 M. sulfur compounds (e.g., sulfolane), acetonitrile, and combinations thereof.

Additionally or alternatively, the electrolyte may include additives, which can, for example, increase temperature and voltage stability of the electrochemical cell materials (e.g., electrolyte 30, negative electrode 22, and positive electrode 24). Examples of suitable additives include, but are not limited to, vinyl carbonate, vinyl-ethylene carbonate, propane sulfonate, and combinations therefore. Other additives can include diluents which do not coordinate with lithium ions but can reduce viscosity, such as bis(2,2,2-trifluoroethyl) ether (BTFE), and flame retardants, such as triethyl phosphate.

### E. Separator

The separator 26 may comprise, for example, a microporous polymeric separator comprising a polyolefin or PTFE. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous separator membranes include CELGARD® 2500 (a monolayer polypropylene separator) and CELGARD® 2325 (a trilayer polypropylene/polyethylene/polypropylene separator) available from Celgard LLC.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), and combinations thereof. The heat-resistant material may be selected from the group consisting of: Nomex, Aramid, and combinations thereof.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics. In certain aspects, the separator 26 may also be mixed with a ceramic material or its surface may be coated in a ceramic material. For example, a ceramic coating may include alumina (Al₂O₃), silicon dioxide (SiO₂), titania (TiO₂) or combinations thereof. Various conventionally available polymers and commercial products for forming the separator 26 are contemplated, as well as the many manufacturing methods that may be employed to produce such a microporous polymer separator 26.

In various aspects, the porous separator 26 and the electrolyte 30 in FIG. 1 may be replaced with a solid-state electrolyte (SSE) (not shown) that functions as both an electrolyte and a separator. The SSE may be disposed between the positive electrode 24 and negative electrode 22. The SSE facilitates transfer of lithium ions, while mechanically separating and providing electrical insulation between the negative and positive electrodes 22, 24. By way of non-limiting example, SSEs may include LiTi₂(PO4)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S-P₂S₅, Li₆PS₅Cl, Li₆PS₅Br, Li₆PS₅I, Li₃OCl, Li_{2.99}Ba_{0.005}ClO, or combinations thereof.

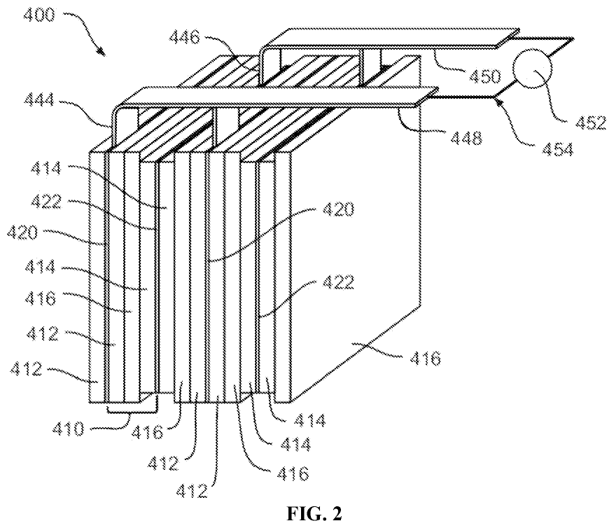

Referring now to FIG. 2, the electrochemical cell 20 (as shown in FIG. 1) may be combined with one or more other electrochemical cells to produce a lithium ion battery 400. The lithium ion battery 400 illustrated in FIG. 2 includes multiple rectangular-shaped electrochemical cells 410. Anywhere from 5 to 150 electrochemical cells 410 may be stacked side-by-side in a modular configuration and connected in series or parallel to form a lithium ion battery 400, for example, for use in a vehicle powertrain. The lithium ion battery 400 can be further connected serially or in parallel to other similarly constructed lithium ion batteries to form a lithium ion battery pack that exhibits the voltage and current capacity demanded for a particular application, e.g., for a vehicle. It should be understood the lithium ion battery 400 shown in FIG. 2 is only a schematic illustration, and is not intended to inform the relative sizes of the components of any of the electrochemical cells 410 or to limit the wide variety of structural configurations a lithium ion battery 400 may assume. Various structural modifications to the lithium ion battery 400 shown in FIG. 2 are possible despite what is explicitly illustrated.

Each electrochemical cell 410 includes a negative electrode 412 (e.g., negative electrode 22), a positive electrode 414 (e.g., positive electrode 24), and a separator 416 situated between the two electrodes 412, 414. Each of the negative electrode 412, the positive electrode 414, and the separator 416 is impregnated, infiltrated, or wetted with a liquid electrolyte (e.g., electrolyte 30) capable of transporting lithium ions. A negative electrode current collector 420 that includes a negative polarity tab 444 is located between the negative electrodes 412 of adjacent electrochemical cells 410. Likewise, a positive electrode current collector 422 that includes a positive polarity tab 446 is located between neighboring positive electrodes 424. The negative polarity tab 444 is electrically coupled to a negative terminal 448 and the positive polarity tab 446 is electrically coupled to a positive terminal 450. An applied compressive force usually presses the current collectors 420, 422, against the electrodes 412, 414 and the electrodes 412, 414 against the separator 416 to achieve intimate interfacial contact between the several contacting components of each electrochemical cell 410.

The battery 400 may include more than two pairs of positive and negative electrodes 412, 414. In one form, the battery 400 may include 15-60 pairs of positive and negative electrodes 412, 414. In addition, although the battery 400 depicted in FIG. 2 is made up of a plurality of discrete electrodes 412, 414 and separators 416, other arrangements are certainly possible. For example, instead of discrete separators 416, the positive and negative electrodes 412, 414 may be separated from one another by winding or interweaving a single continuous separator sheet between the positive and negative electrodes 412, 414. In another example, the battery 400 may include continuous and sequentially stacked positive electrode, separator, and negative electrode sheets folded or rolled together to form a “jelly roll.”

The negative and positive terminals 448, 450 of the lithium ion battery 400 are connected to an electrical device 452 as part of an interruptible circuit 454 established between the negative electrodes 412 and the positive electrodes 414 of the many electrochemical cells 410. The electrical device 452 may comprise an electrical load or power-generating device. An electrical load is a power-consuming device that is powered fully or partially by the lithium ion battery 400. Conversely, a power-generating device is one that charges or re-powers the lithium ion battery 400 through an applied external voltage. The electrical load and the power-generating device can be the same device in some instances. For example, the electrical device 452 may be an electric motor for a hybrid electric vehicle or an extended range electric vehicle that is designed to draw an electric current from the lithium ion battery 400 during acceleration and provide a regenerative electric current to the lithium ion battery 400 during deceleration. The electrical load and the power-generating device can also be different devices. For example, the electrical load may be an electric motor for a hybrid electric vehicle or an extended range electric vehicle and the power-generating device may be an AC wall outlet, an internal combustion engine, and/or a vehicle alternator.

The lithium ion battery 400 can provide a useful electrical current to the electrical device 452 by way of the reversible electrochemical reactions that occur in the electrochemical cells 410 when the interruptible circuit 454 is closed to connect the negative terminal 448 and the positive terminal 450 at a time when the negative electrodes 412 contain a sufficient quantity of intercalated lithium (i.e., during discharge). When the negative electrodes 412 are depleted of intercalated lithium and the capacity of the electrochemical cells 410 is spent. The lithium ion battery 400 can be charged or re-powered by applying an external voltage originating from the electrical device 452 to the electrochemical cells 410 to reverse the electrochemical reactions that occurred during discharge.

Although not depicted in the drawings, the lithium ion battery 400 may include a wide range of other components. For example, the lithium ion battery 400 may include a casing, gaskets, terminal caps, and any other desirable components or materials that may be situated between or around the electrochemical cells 410 for performance related or other practical purposes. For example, the lithium ion battery 400 may be enclosed within a case (not shown). The case may comprise a metal, such as aluminum or steel, or the case may comprise a film pouch material with multiple layers of lamination. It is contemplated herein that the electrochemical cell 20, 400 that is formed may be a pouch cell, coin cell, or another full electrochemical cell having a cylindrical format or wounded prismatic format

### II. Methods of Preparing an Electrode

Methods of preparing an electrode, for example, positive electrode 24, are also provided herein. The method includes combining one or more first metal precursor, a second metal precursor, and a solution to form a precursor mixture. The one or more first metal precursor(s) may be one or more salt(s) of a first metal and the second metal precursor may be a salt, an acid, or an oxide, of a second metal. Salts include, but are not limited to, nitrates, acetates, sulfates, oxalates, chloride, ammonium salts, or combinations thereof. It is contemplated herein that the salt may be in hydrate form. The first metal may be selected from the group consisting of lithium, manganese, nickel, cobalt, and combinations thereof. The second metal may be selected from the group consisting of tungsten, molybdenum, vanadium, zirconium, niobium, tantalum, iron, aluminum, and combinations thereof. Examples of the first metal precursor include, but are not limited to, lithium nitrate (LiNO₃), manganese nitrate (Mn(NO₃)₂), nickel nitrate (Ni(NO₃)₂), cobalt nitrate (Co(NO₃)₂), or combinations thereof. In any embodiment, the one or more first metal precursor may be a combination of lithium nitrate (LiNO₃), manganese nitrate (Mn(NO₃)₂), nickel nitrate (Ni(NO₃)₂), and cobalt nitrate (Co(NO₃)₂. Examples of the second metal precursor include, but are not limited to, (NH₄)₁₀(H₂W₁₂O₄₂), (NH₄)₆W₁₂O₃₉, H₃PW₁₂O₄₀, WO₃ H₂WO₄, (NH₄)₂Mo₂O₇, (NH₄)₆Mo₇O_{24,} NH₄VO₃, zirconium nitrate (Zr(NO₃)₄), ZrO(NO₃)₂, niobium nitrate (Nb(NO₃)₅), tantalum nitrate (Ta(NO₃)₅), NbCl₅, TaCl₅, iron nitrate (Fe(NO₃)₃, iron acetate (C₁₄H₂₇Fe₃O₁₈), iron oxalate (Fe(C₂O₄), Fe₂(C₂O₄)₃, aluminum nitrate (Al(NO₃)₃), or combinations thereof. In any embodiment, the second metal precursor may be (NH₄)₁₀(H₂W₁₂O₄₂), (NH₄)₆W₁₂O_{39,} (NH₄)₂Mo₂O₇, (NH₄)₆Mo₇O₂₄, NH₄VO₃, ZrO(NO₃)₂, Nb(NO₃)₅, Nb(NO₃)₅, NbCl₅, TaCl₅, or combinations thereof. In some embodiments, the second metal precursor may be (NH₄)₁₀(H₂W₁₂O₄₂), (NH₄)₂Mo₂O₇, or a combination thereof. The solution may be an aqueous solution including water and one or more of: a weak acid (e.g., citric acid, formic acid, acetic acid, trichloroacetic acid, hydrofluoric acid, hydrocyanic acid, hydrogen sulfide, etc.), a sugar (e.g., sucrose), and an alcohol (e.g., ethanol).

Additionally, the method may further include a drying step including drying the precursor mixture to form an intermediate mixture, for example, a solid intermediate mixture in particle or powder form. Prior to drying, the precursor mixture may be mixed for a suitable amount of time (e.g., about 1 hour to about 15 hours or about 2 hours to about 12 hours) and/or at a suitable temperature, for example, about 50° C. to about 200° C., about 75° C. to about 150° C., about 80° C. to about 125° C., about 90° C. to about 110° C., or about 95° C. to about 100° C. Drying includes heating the precursor mixture, for example, in an oven, to a temperature of about 150° C. to about 500° C., about 200° C. to about 400° C., about 250° C. to about 350° C., or about 275° C. to about 325° C. It is also contemplated herein that drying can include grinding the intermediate mixture to form particles or a powder, for example, via ball milling.

The method may further include a calcining step including calcining, heating, or annealing the intermediate mixture to form a calcined intermediate mixture. Calcining may be performed, for example, in an oven with or without air flowing, at a suitable temperature, for example, about 600° C. to about 1500° C., about 700° C. to about 1250° C., about 700° C. to about 1000° C., about 800° C. to about 1000° C., or about 850° C. to about 950° C. Additionally or alternatively, calcining can be performed in a suitable environment, for example, air or an inert gas (e.g., N₂, Ar, etc.), for a suitable amount of time, for example, about 5 hours to about 50 hours, about 10 hours to about 30 hours, or about 15 to about 25 hours.

Additionally or alternatively, the method may further include a quenching step, wherein the calcined intermediate mixture may be quenched to form the first electroactive material as described herein. Quenching may include maintaining the calcined intermediate mixture at room temperature for a suitable amount of time (e.g., about 30 minutes to about 4 hours or about 1 hour to about 3 hours). For example, the calcined intermediate mixture may be removed from the calcining environment (e.g., an oven) and maintained at temperature of about 15° C. to about 25° C. or about 18° C. to about 22° C. It is contemplated herein that quenching may not include further heating of the calcined intermediate mixture. For example, the first electroactive material formed may comprise Li₁₊ₐNi_{b}Mn_{c}Co_{d}MₑO₂, where 0.5≤a≤0.5; 0.1≤b≤0.5; 0.3<c≤0.8; zero (0) ≤d≤0.3; 0.001≤e≤0.1; a+b+c+d+e=1; and M represents an additional metal selected from the group consisting of W, Mo, V, Zr, Nb, Ta, Fe, Al, and a combination thereof. The method described herein may advantageously achieve doping of the additional metal within the first electroactive material. Without being bound by theory, it is believed that by quenching the calcined intermediate mixture at room temperature the structure of the first electroactive material, for example, with the additional metal doped within, may become locked and contribute to the positive electrode's greater capacity and increased cycling stability.

Alternatively, a further method for forming an electrode, such as positive electrode 24, is also provided herein. The method may include combining a first metal precursor as described herein and a solution as described herein to form a first precursor mixture. The first precursor mixture may undergo one or more of: the drying step as described herein, the calcining step as described herein, and the quenching step as described herein to form an initial metal electroactive material. The initial metal electroactive material may be combined with a solution comprising the additional metal described herein, for example, a solution comprising W, Mo, V, Zr, Nb, Ta, Fe, Al, and a combination thereof, to form a second precursor mixture. The solution may comprise a solvent, such as an alcohol (e.g., ethanol), and the additional metal, for example, an oxide of the additional metal, such as, but not limited to, aluminum isopropoxide, MoO₃, WO₃, (NH₄)₁₀(H₂W₁₂O₄₂), and (NH₄)₂Mo₂O₇. The second precursor mixture may undergo one or more of the drying step as described herein, the calcining step as described herein, and the quenching step as described herein to form a first electroactive material. The method described herein may achieve formation of metal oxide layer comprising the additional metal on the first electroactive material. Additionally or alternatively, formation of a metal oxide layer comprising the additional metal on the first electroactive material may be achieved, for example, as described in S-T Myung et al., Chem. Mater. 17 (2005), pp. 3695-3704 or Q. Qiu et al., Ceramics International, 40 (2014), pp. 10511-10516, the relevant portions of each of which are incorporated by reference herein.

Additionally or alternatively, first electroactive material may be combined with a solvent to form a slurry. The slurry may applied to a current collector as described herein. Non-limiting examples of suitable solvents include xylene, hexane, methyl ethyl ketone, acetone, toluene, dimethylformamide, aromatic hydrocarbons, n-methyl-2-pyrrolidone (NMP), and combinations thereof. Examples of a slurry application device include, but are not limited to, a knife, a slot die, direct gravure coating, or micro-gravure coating. Following application of the slurry onto the current collector, the method may further include a drying or volatilization step to remove the solvent present in the applied slurry to form the electrode. Drying can be performed at a temperature suitable to volatilize the solvent, for example, about 45° C. to 150° C. The methods may be performed at low humidity conditions, e.g., at 10% relative humidity (RH) or lower, e.g., 5% RH, 1% RH (−35° C. or lower dew point). The methods may be performed a temperature of 5° C. to 150° C.

### EXAMPLES

### General Information

Unless otherwise indicated below, each of the cells prepared in the Examples below were composed of:
a cathode including an electroactive material a described below (80 wt. % and 8-9 mg/cm² electroactive material loading), PVDF polymeric binder (10 wt. %), and carbon black (10 wt. %);
a Li metal anode; and
80 μl 1.2 M LiPF₆ (1:4 fluoroethylene carbonate/dimethyl carbonate) as the electrolyte with a separator (Celgard® 2320).
   The areal capacity of the cells was 1.4 mAh/cm² (assuming 170 mAh/g capacity).

Unless otherwise indicated below, each of the cathodes and cells prepared in the Examples below were tested as follows:

Formation cycle (2 cycles):
Charge: constant current charging at C/20 to 4.7 V and constant voltage charging at 4.7 V until C/50.
Discharge: constant current charging at C/20 to 2.0 V.

### Cycling:

Charge: constant current charging at C/5 to 4.6 V and constant voltage charging at 4.6 V until C/20.
Discharge: constant current charging at C/5 to 2.0 V.

### Example 1—Preparation of Electroactive Material and Cathodes

The following electroactive materials were prepared as shown below in

Table 1.

TABLE 1

| Electroactive Material | Composition |
|---|---|
| 1 | Li_{1.2}Ni_{0.16}Mn_{0.56}Co_{0.08}O₂ |
| 2 | Li_{1.2}Ni_{0.16}Mn_{0.51}Co_{0.08}Al_{0.05}O₂ |
| 3 | Li_{1.2}Ni_{0.16}Mn_{0.55}Co_{0.08}W_{0.01}O₂ |
| 4 | Li_{1.2}Ni_{0.16}Mn_{0.54}Co_{0.08}Mo_{0.02}O₂ |

The electroactive materials for the cathodes were synthesized using the following precursors at the designated compositions shown below in Table 2.

TABLE 2

| | Electroactive Material | | | |
|---|---|---|---|---|
| | 1 | 2 | 3 | 4 |
| LiNO₃ | 4.95 g | 5.04 g | 4.88 g | 4.91 g |
| Ni(NO₃)₂ · 6H₂O | 2.73 g | 2.78 g | 2.69 g | 2.70 g |
| Mn(NO₃)₂ | 11.76 g | 10.89 g | 11.38 g | 10.61 g |
| 50% solution | | | | |
| Co(NO₃)₂ · 6H₂O | 1.37 g | 1.39 g | 1.35 g | 1.35 g |
| (NH₄)₆W₁₂O₃₉ · xH₂O | — | — | 0.14 g | — |
| (NH₄)₆Mo₇O₂₄ · 4H₂O | — | — | — | 0.21 g |
| Al(NO₃)₃ · 9H₂O | — | 1.12 g | — | — |
| Citric Acid | 24 g | 24 g | 24 g | 24 g |
| Water | 60 g | 60 g | 60 g | 60 g |

The metal salts along with citric acid (mole ratio of citric acid/total metals =1-1.2) were dissolved in water with continuous stirring to form a uniform precursor. The solution was evaporated slowly by heating at about 100° C. to produce a syrupy mass, which upon further heating at 300° C. for 1-5 hours in air led to the formation of an amorphous compound. This amorphous compound was ground to get a fine powder sample, which was then annealed at 700° C. for 1-5 hours in air. This product was again ground and annealed at 900° C. for 20 hours in air, and then quenched at room temperature in air.

To form Cathodes 1-4 with respective Electroactive Materials 1-4, respective slurries were prepared by mixing 80 wt. % Electroactive Materials 1-4, 10 wt. % of conductive super P carbon, and 10 wt. % of PVDF binder in N-methyl-2-pyrrolidinone (NMP). Cathodes 1-4 were prepared by casting these respective slurries onto Al foils current collectors by using a doctor-blade. The active mass coated on the Al foil was dried at 60° C. for 12 h in a vacuum oven and was calendared uniformly after drying. Circular Cathodes 1-4 of 12.5 mm diameter were then prepared. Cathodes 1-4 were finally dried at 60° C. for 12 h in a vacuum oven in order to remove any absorbed moisture or trace NMP.

### Example 2—Preparation and Testing of Cells

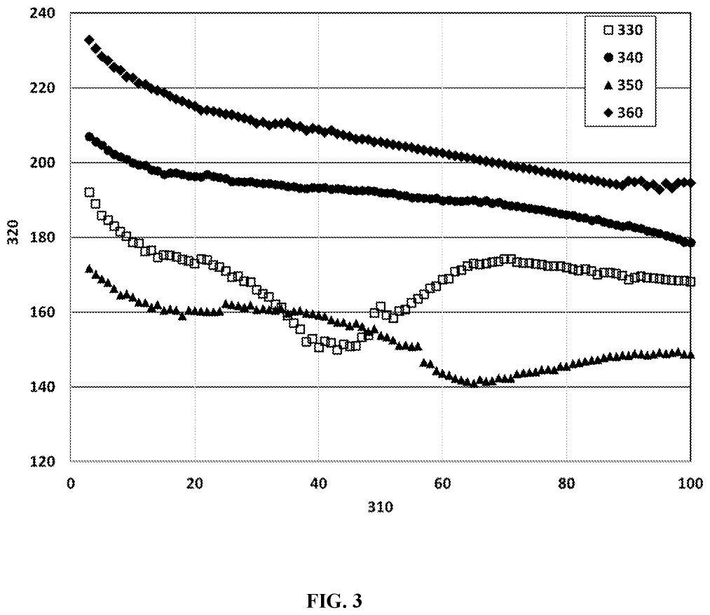

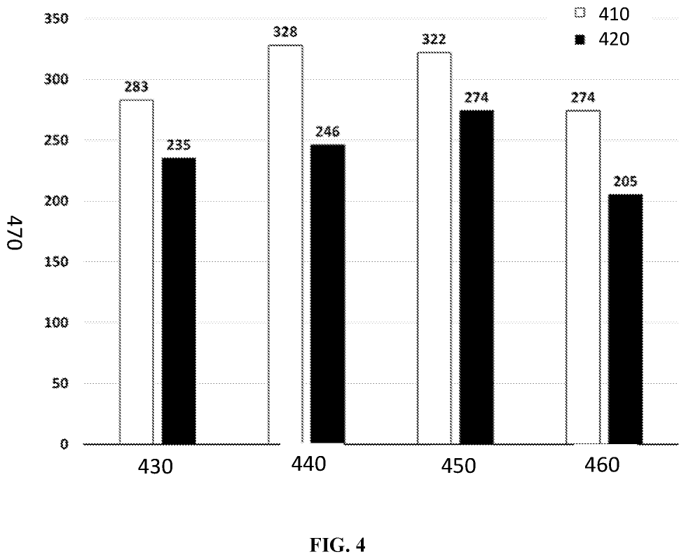

Cells 1-4 were each prepared with respective Cathodes 1-4 and an anode, a separator, and an electrolyte as described above. Each of Cells 1-4 were cycled as described above. The results for the half cell (anode) are shown in FIGS. 3 and 4. In FIG. 3, the x-axis (310) is cycle number, while discharge capacity (mAh/g) is shown on the y-axis (320) for Cell 1 (330), Cell 2 (340), Cell 4 (350), and Cell 3 (360). The results of the charge/discharge capacity of the first formation cycle (C/20) are shown in FIG. 4. In FIG. 4, the x-axis shows charging capacity 410 and discharging capacity 420 for each of Cell 1 (430), Cell 2 (440), Cell 3 (450), and Cell 4 (460), while charging capacity (mAh/g) is shown on the y-axis (470). Cell 3 had the highest efficiency of 85%.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode comprising:
a first electroactive material comprising Li₁₊ₐNi_{b}Mn_{c}Co_{d}MₑO₂, where 0.05≤a≤0.5; 0.1≤b≤0.5; 0.3≤c≤0.8; 0≤d≤0.3; 0.001≤e≤0.1; a+b+c+d+e=1; and M represents an additional metal selected from the group consisting of W, Mo, V, Zr, Nb, Ta, Fe, Al, and a combination thereof.

2. The electrode of claim 1, wherein the additional metal is present:
(i) doped within the first electroactive material;
(ii) as a metal oxide layer; or
(iii) a combination thereof.

3. The electrode of claim 2, wherein one or more of the following are satisfied:
(i) the metal oxide layer is present on a surface of the first electroactive material; and
(ii) the metal oxide layer has a thickness of about 1 nm to about 100 nm.

4. The electrode of claim 1, wherein M is selected from the group consisting of W, Mo, V, Zr, Nb, Ta, Fe, and a combination thereof.

5. The electrode of claim 1, wherein M is W, Mo, or a combination thereof.

6. The electrode of claim 1, wherein the first electroactive material is present in an amount of about 40 wt. % to about 95 wt. %, based on total weight of the electrode.

7. The electrode of claim 1, further comprising a polymeric binder, an electrically conductive material, or a combination thereof.

8. An electrochemical cell comprising:
a positive electrode comprising:
a first electroactive material comprising Li₁₊ₐNi_{b}Mn_{c}Co_{d}MₑO₂, where 0.05≤a≤0.5; 0.1≤b≤0.5; 0.3≤c≤0.8; 0≤d ≤0.3; 0.001−e ≤0.1; a+b+c+d+e=1; and M represents an additional metal selected from the group consisting of W, Mo, V, Zr, Nb, Ta, Fe, Al, and a combination thereof.
a negative electrode comprising a second electroactive material, wherein the positive electrode is spaced apart from the negative electrode;
a porous separator disposed between confronting surfaces of the positive electrode and the negative electrode; and
a liquid electrolyte infiltrating one or more of: the positive electrode, the negative electrode, and the porous separator.

9. The electrochemical cell of claim 8, wherein the additional metal is present:
(i) doped within the first electroactive material;
(ii) as a metal oxide layer; or
(iii) a combination thereof.

10. The electrochemical cell of claim 8, wherein one or more of the following are satisfied:
(i) the metal oxide layer is present on a surface of the first electroactive material; and
(ii) the metal oxide layer has a thickness of about 1 nm to about 100 nm.

11. The electrochemical cell of claim 8, wherein M is selected from the group consisting of W, Mo, V, Zr, Nb, Fe, Ta, and a combination thereof.

12. The electrochemical cell of claim 8, wherein M is W, Mo, or a combination thereof.

13. The electrochemical cell of claim 8, wherein the first electroactive material is present in an amount of about 40 wt. % to about 95 wt. %, based on total weight of the positive electrode.

14. The electrochemical cell of claim 8, wherein the second electroactive material comprises metallic lithium, a lithium alloy, silicon, graphite, activated carbon, carbon black, hard carbon, soft carbon, graphene, tin oxide, aluminum, indium, zinc, germanium, silicon oxide, titanium oxide, lithium titanate, and a combination thereof.

15. The electrochemical cell of claim 10, wherein each of the positive electrode and the negative electrode further comprise a polymeric binder, an electrically conductive material, or a combination thereof.

16. A method of preparing an electrode, the method comprising:
combining one or more first metal precursor, a second metal precursor, and a solution to form a precursor mixture, wherein the one or more first metal precursor is one or more salt of a first metal, wherein the first metal is selected from the group consisting of lithium, manganese, nickel, cobalt, and a combination thereof, and wherein the second metal precursor is a salt, an acid, or an oxide of a second metal, wherein the second metal is selected from the group consisting of tungsten, molybdenum, vanadium, zirconium, niobium, tantalum, iron, aluminum, and a combination thereof;
drying the precursor mixture to form an intermediate mixture;
calcining the intermediate mixture at a temperature of about 700° C. to about 1250° C. for about 10 hours to about 30 hours to form a calcined intermediate mixture; and
quenching the calcined intermediate mixture at a temperature of about 15° C. to about 25° C. to form a first electroactive material comprising Li₁₊ₐNi_{b}Mn_{c}Co_{d}MₑO₂, where 0.05≤a≤0.5; 0.1≤b≤0.5; 0.3≤c≤0.8; 0≤d≤0.3; 0.001≤e ≤0.1; a+b+c+d+e=1; and M represents an additional metal selected from the group consisting of W, Mo, V, Zr, Nb, Ta, Fe, Al, and a combination thereof.

17. The method of claim 16, further comprising:
combining the first electroactive material with a solvent to form a slurry;
applying the slurry to a current collector; and
drying the slurry to remove the solvent and form the electrode.

18. The method of claim 16, wherein the additional metal is present:
(i) doped within the first electroactive material;
(ii) as a metal oxide layer; or
(iii) a combination thereof.

19. The method of claim 16, wherein one or more of the following are satisfied:
(i) the metal oxide layer is present on a surface of the first electroactive material; and
(ii) the metal oxide layer has a thickness of about 1 nm to about 100 nm.

20. The method of claim 16, wherein M is selected from the group consisting of W, Mo, V, Zr, Nb, Ta, Fe, and a combination thereof.
